(19) United States
(12) Patent Application Publication
(10) Pub. No.: US 2024/0361555 A1
(43) Pub. Date: Oct. 31, 2024

(54) PANEL SYSTEMS WITH SLIDABLE CASSETTES

(71) Applicant: CommScope Technologies LLC, Hickory, NC (US)

(72) Inventor: David Jan Irma VAN BAELEN, Winksele (BE)

(73) Assignee: CommScope Technologies LLC, Hickory, NC (US)

(21) Appl. No.: 18/579,187

(22) PCT Filed: Jul. 14, 2022
(86) PCT No.: PCT/US2022/037164

§ 371 Date: Jan. 12, 2024

Related U.S. Application Data
(60) Provisional application No. 63/222,710, filed on Jul. 16, 2021.

(51) Int. Cl. G02B 6/44

(52) U.S. Cl. CPC G02B 6/4455; G02B 6/44526

(57) ABSTRACT

A chassis defines one or more chambers within the interior. Each chamber includes guides along which one or more cassettes can be mounted. Some chambers are configured to receive cassettes in a row. Other chambers are configured to receive cassettes in a column. The cassettes slide along and latch to the guides. The cassettes carry forward port members configured to receive one or more plug connectors, such as SN plugs, duplex LC plugs, MPO plugs, at mounting positions forward of the main bodies of the cassettes.

### CROSS-REFERENCE TO RELATED APPLICATION

This application is being filed on Jul. 14, 2022 as a PCT International Patent Application and claims the benefit of U.S. Patent Application Ser. No. 63/222,710, filed on Jul. 16, 2021, the disclosure of which is incorporated herein by reference.

### BACKGROUND

In the telecommunications industry, the demand for added capacity is growing rapidly. This demand is being met in part by the increasing use and density of fiber optic transmission equipment. Even though fiber optic equipment permits higher levels of transmission in the same or smaller footprint than traditional copper transmission equipment, the demand requires even higher levels of fiber density. This has led to the development of high-density fiber handling equipment.

In communications panel systems, port members (e.g., optical adapters, electrical jacks, hybrid port members, etc.) defining front ports are mounted to one or more trays that are disposable within a chassis. The front ports are configured to receive plug connectors at the fronts of the trays. The trays can either be stationary within a chassis or can slide forwardly of the chassis to enhance access to the port members.

Improvements are desired.

### SUMMARY

Some aspects of the disclosure are directed to a fiber panel system including a spacer wall disposed within a chassis. A first side of the spacer wall defines a first plurality of parallel guides extending along the forward-rearward axis. A second side of the spacer wall defines a second plurality of parallel guides extending along the forward-rearward axis. The second guides are offset from the first guides along a height of the chassis.

In certain implementations, multiple spacer walls cooperate to define chambers within the chassis. In certain examples, spacer walls can be stacked to provide multiple layers of chambers.

In some implementations, the guides are arranged in a single row within each chamber. Accordingly, multiple cassettes can be mounted side-by-side within a chamber. In other implementations, the guides are arranged in columns with the chambers. Accordingly, multiple cassettes can be stacked in a column with each chamber.

In certain implementations, each cassette is configured to receive multiple forward port members. Each forward port member is configured to receive one or more plug connectors. In some examples, a forward port member is configured to receive SN plug connectors. In other examples, a forward port member is configured to receive duplex LC plug connectors. In other examples, a forward port member is configured to receive MPO plug connectors. In certain examples, a forward port member is configured to receive a plug connector in a vertical orientation (where the plug extends farther in the vertical orientation than in the horizontal orientation).

In certain implementations, a cassette holds the forward port members at positions forward of a main body of the cassette. In some examples, the port members are attached to the cassette using separate resilient support members. In other examples, the port members have rearwardly-extending latching arms that snap-fit within the main body of the cassette. In other examples, the port members have latching tabs that snap-fit to arms extending forwardly of the main body of the cassette. In still other examples, the port members slidingly interlock to the cassette.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example fiber panel including a chassis defining multiple chambers in each of which multiple cassettes are mountable along guides, the fiber panel configured in accordance with the principles of the present disclosure;

FIG. 2 is a rear elevational view of a portion of the fiber panel of FIG. 1;

FIG. 3 is an exploded view of the fiber panel of FIG. 1;

FIG. 4 is a perspective view of a cross-section taken of the fiber panel of FIG. 1;

FIG. 5 is a top perspective view of an example cassette suitable for mounting within the fiber panel of FIG. 1;

FIG. 6 is a bottom perspective view of the cassette of FIG. 5;

FIG. 7 is a perspective view of another example fiber panel including a chassis defining multiple chambers in each of which multiple cassettes are mountable along guides, the fiber panel configured in accordance with the principles of the present disclosure;

FIG. 8 is a front elevational view of a portion of the fiber panel of FIG. 7;

FIG. 9 is an exploded view of the fiber panel of FIG. 7;

FIG. 10 is a first perspective view of a first side of an example spacer wall suitable for use in the fiber panel of FIG. 7;

FIG. 11 is a second perspective view of an opposite second side of the spacer wall of FIG. 10;

FIG. 12 is a perspective view of a cross-section taken of the fiber panel of FIG. 7;

FIG. 13 is a perspective view of another example fiber panel including a chassis defining multiple chambers in each of which multiple cassettes are mountable along guides, the fiber panel configured in accordance with the principles of the present disclosure and being shown with one cassette mounted therein;

FIG. 14 is a rear perspective view of the fiber panel of FIG. 13, except that two cassettes are mounted therein;

FIG. 15 shows the fiber panel of FIG. 13 having one chamber populated by cassettes carrying SN port members, another chamber populated by cassettes carrying duplex LC port members, and a third chamber empty of cassettes;

FIG. 16 is a rear perspective view of another fiber panel similar to the fiber panel of FIG. 13 except having four chambers instead of three, all of the chambers being shown fully populated;

FIG. 17 is a front elevational view of a portion of the fiber panel of FIG. 15 with some of the plug connectors removed for ease in viewing the forward port members;

FIG. 18 is a rear elevational view of the portion of the fiber panel of FIG. 17;

FIG. 19 is an exploded view of the fiber panel of FIG. 13;

FIG. 20 is a top perspective view of a first side of an example spacer wall suitable for use in the fiber panels of FIGS. 13 and 15;

FIG. 21 is a top perspective view of a second side of the spacer wall of FIG. 20;

FIG. 22 is a bottom perspective view of the second side of the spacer wall of FIG. 20;

FIG. 23 shows an example cassette exploded forwardly from the fiber panel of FIG. 15;

FIG. 24 is a perspective view of an example cross-section taken of the fiber panel of FIG. 13;

FIG. 25 is an exploded view of a cassette having a first example port member mounting arrangement suitable for use with any of the cassettes disclosed herein;

FIG. 26 shows an example support member of the first example port member mounting arrangement disposed at a mounting position of the cassette;

FIG. 27 shows the support members of FIG. 26 mounted to the port members exploded forwardly of the example cassette of FIG. 25;

FIG. 28 is a perspective view of a transvers cross-section of an example port member mounted to the cassette of FIG. 25 using the first example port member mounting arrangement;

FIG. 29 is another perspective view of a cross-section of the port member and first port member mounting arrangement of FIG. 28 with the port member shows raised off the support member for ease in viewing;

FIG. 30 is an exploded view of a cassette having a second example port member mounting arrangement suitable for use with any of the cassettes disclosed herein;

FIG. 31 is a cross-section of a forward end of the cassette of FIG. 30;

FIG. 32 is an exploded view of a cassette having a third example port member mounting arrangement suitable for use with any of the cassettes disclosed herein;

FIG. 33 is a cross-section of a forward end of the cassette of FIG. 32;

FIG. 34 is an exploded view of a cassette having a fourth example port member mounting arrangement suitable for use with any of the cassettes disclosed herein;

FIG. 35 shows the cassette of FIG. 34 from an opposite side thereof;

FIG. 36 is a transverse cross-section of one of the port members and chambers of the cassette of FIG. 35 when the port member is mounted at the cassette;

FIG. 37 is a bottom perspective view of an example cassette carrying multiple vertically oriented MPO type port members; and

FIG. 38 is a front perspective view of the fiber panel of FIG. 15 populated with the cassettes of FIG. 37.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A fiber panel system 100, 200, 300 includes a chassis 102, 202, 302 defining a plurality of chambers 104, 204, 304 in which one or more cassettes 106, 206, 306 can be mounted. The chassis 102, 202, 302 has a depth extending along a forward-rearward axis FR between a front and a rear, a width extending along a lateral axis LA between opposite first and second sides, and a height H extending between a top and a bottom. The depth, width, and height are all transverse to each other. Each of the chambers 104, 204, 304 extends along the forward-rearward axis FR. In certain examples, the chassis 102, 202, 302 defines multiple levels or chambers 104, 204, 304.

In certain examples, the width of the fiber panel system 100, 200, 300 is configured to fit within a standard telecommunications rack. In some examples, the width is sized to fit within a 19 inch rack. In other examples, the width is sized to fit within a 23 inch rack. In certain examples, the height H of the fiber panel system 100, 200, 300 is a standard rack unit (i.e., 1 RU). Other sizes are possible.

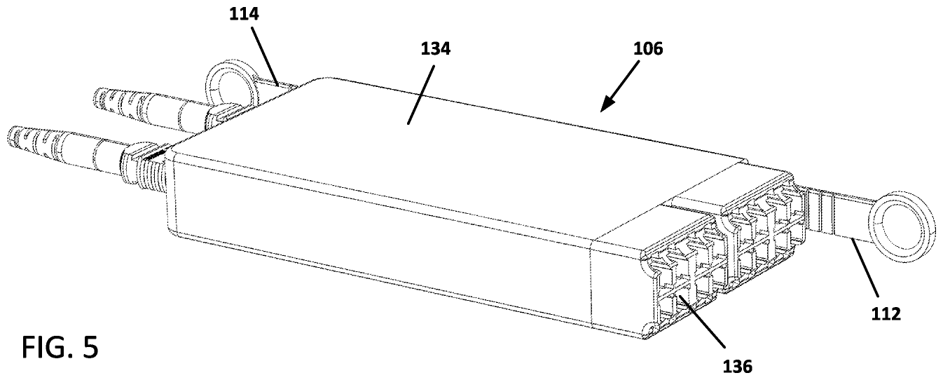

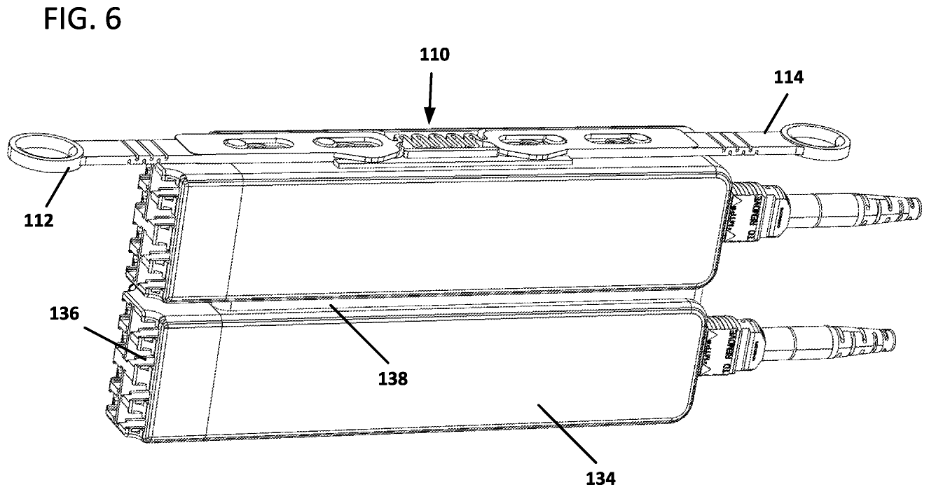

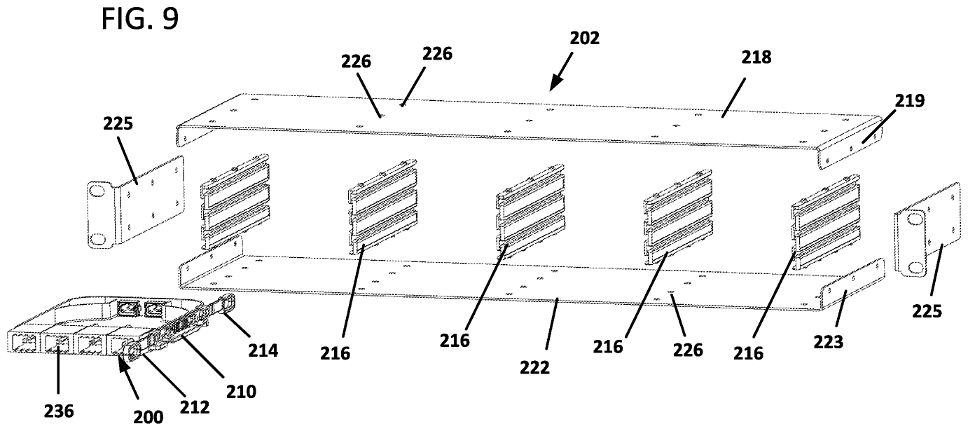

In certain implementations, each cassette 106, 206, 306 includes a cassette body 134, 234, 334 carrying a plurality of front port members 136, 236, 336. In certain examples, the front port members 136, 236, 336 define front ports accessible from an exterior of the cassette body 134, 234, 334 and rear ports accessible from an interior of the cassette body 134, 234, 334. In certain examples, the cassette body 134, 234, 334 may carry one or more rear port members 490 having rear ports accessible from the exterior of the cassette body 134, 234, 334 and front ports accessible from the interior of the cassette body 134, 234, 334. In some examples, the interior of the cassette body 134, 234, 334 is enclosed by a cassette cover (e.g., see FIG. 5). In other examples, the interior of the cassette body 134, 234, 334 has an open top (e.g., see FIG. 9).

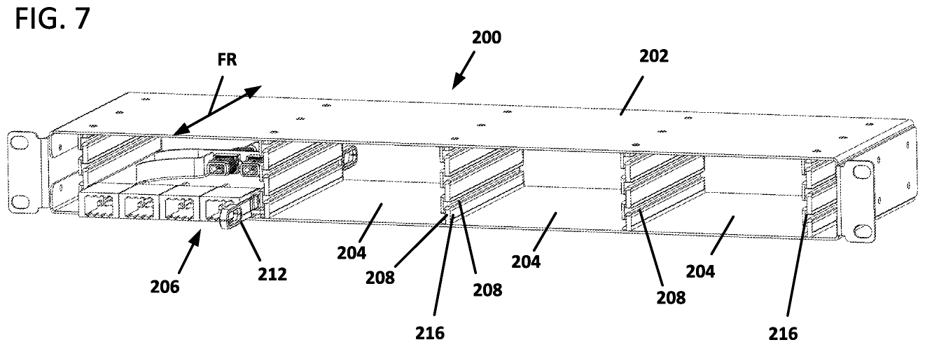

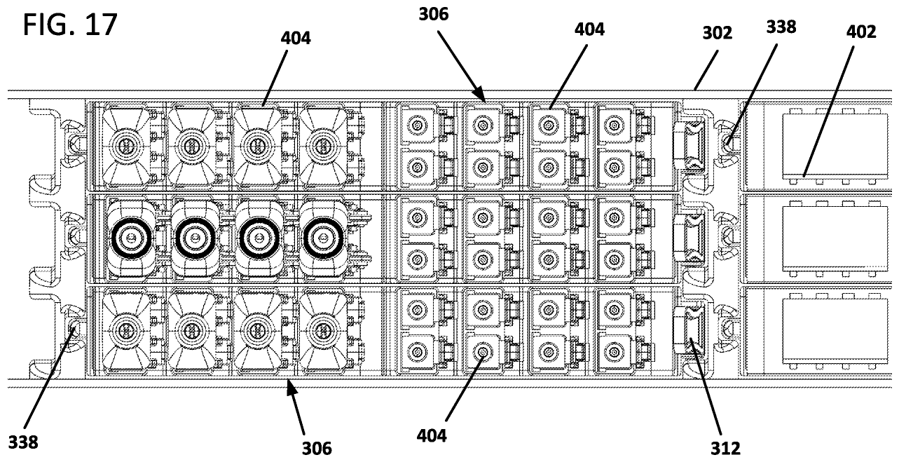

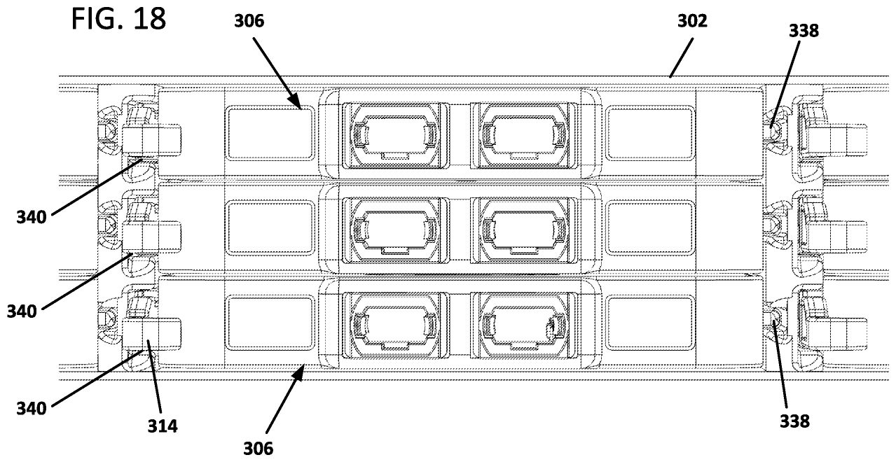

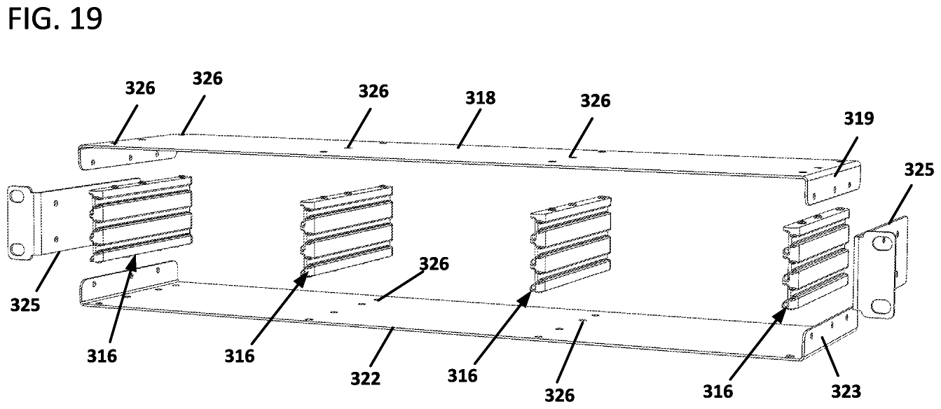

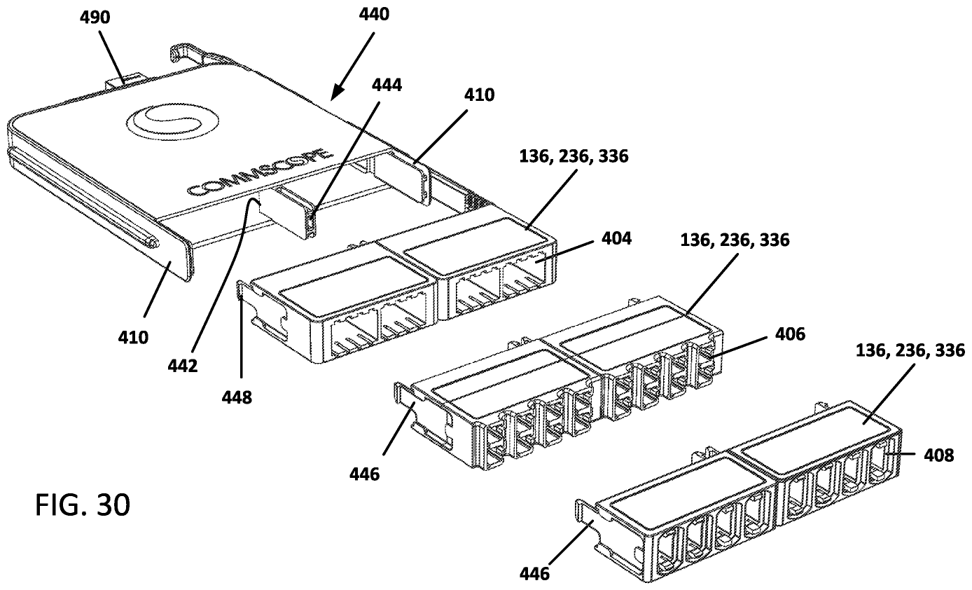

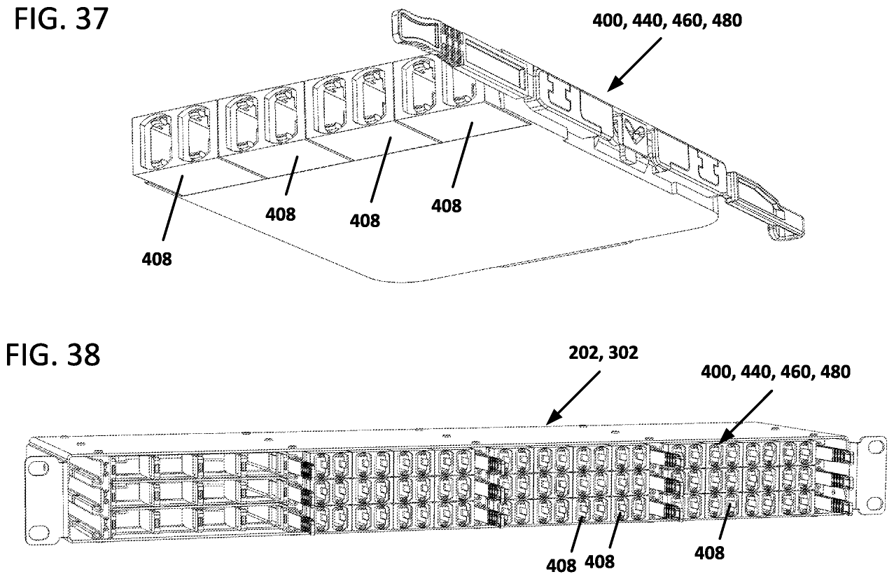

In certain implementations, each cassette 106, 206, 306 is configured to receive any of multiple types 404, 406, 408 of forward port members 136, 236, 336 (e.g., see FIG. 30). For example, a first type 404 of forward port member 136, 236, 336 is configured to receive multiple SN plug connectors. A second type 406 of forward port member 136, 236, 336 is configured to receive multiple duplex-LC plug connectors. A third type 408 of forward port member 136, 236, 336 is configured to receive multiple MPO plug connectors. In the examples shown, each of the port member types 404, 406, 408 receive the respective plug connectors in a vertical orientation so that a widest portion of the plug connector extends along the height H of the chassis 102, 202, 302 (e.g., see FIGS. 7, 17, and 37). Other configurations are possible. For example, the port members may be configured to receive single-fiber plug connectors, electrical plug connectors, or hybrid plug connectors. In other examples, the forward port members are configured to receive and anchor cables fed into the cassette 106, 206, 306.

In certain examples, each cassette 106, 206, 306 can be mounted within one of the chambers 104, 204, 304 from either a front of the chassis 102, 202, 302 or a rear of the chassis 102, 202, 302 at a discretion of the user. In certain examples, multiple cassettes 106, 206, 306 are mounted in a single chamber 104, 204, 304. In some examples, the cassettes 106, 206, 306 can be vertically stacked in each chamber 104, 204, 304. In other examples, the cassettes 106, 206, 306 can be arranged in a row within each chamber 104, 204, 304.

In certain implementations, a plurality of guides 108, 208, 308 are disposed within each chamber 104, 204, 304. Each guide 108, 208, 308 extends along the forward-rearward axis FR and defines a stop position. In certain implementations, each cassette 106, 206, 306 carries a latching arrangement 110, 210, 310 that selectively latches and unlatches the cassette 106, 206, 306 to the guide 108, 208, 308 at the respective stop position.

The latching arrangement 110, 210, 310 includes a forwardly extending arm 112, 212, 312 that is movable along the forward-rearward axis FR between a neutral position and an actuated position. When the arm 112, 212, 312 is in the actuated position, the latching arrangement 110, 210, 310 releases the cassette 106, 206, 306 from the chassis 102, 202, 302. When the arm 112, 212, 312 is in the neutral position, the latching arrangement 110, 210, 310 latches to the guide 108, 208, 308 when aligned at the stop position. In certain examples, the actuated position is forward of the neutral position. In certain examples. the arm latching arrangement 110, 210, 310 is released when moving the arm 112, 212, 312 in either direction along the forward-rearward axis FR. In certain examples, the arm 112, 212, 312 is spring-biased to the neutral position.

In certain implementations, the latching arrangement 110, 210, 310 also includes a rearwardly extending arm 114, 214, 314 that is movable along the forward-rearward axis FR between a neutral position and a second actuated position. When the rearward arm 114, 214, 314 is in the second actuated position, the latching arrangement 110, 210, 310 releases the cassette 106, 206, 306 from the chassis 102, 202, 302. When the second arm 114, 214, 314 is in the neutral position, the latching arrangement 110, 210, 310 latches to the guide 108, 208, 308 when aligned at the stop position. In certain examples, the second arm 114, 214, 314 is spring-biased to the neutral position.

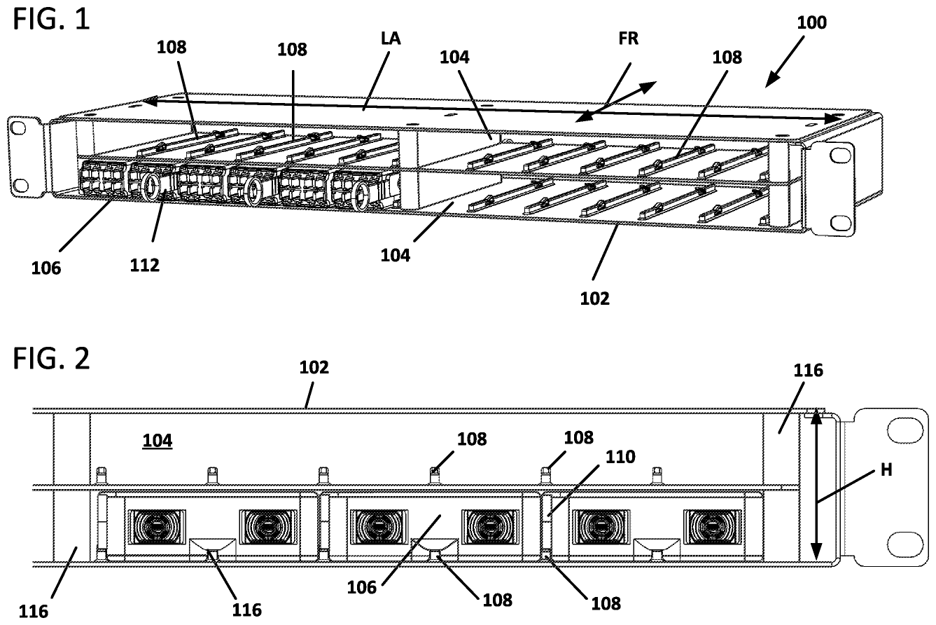

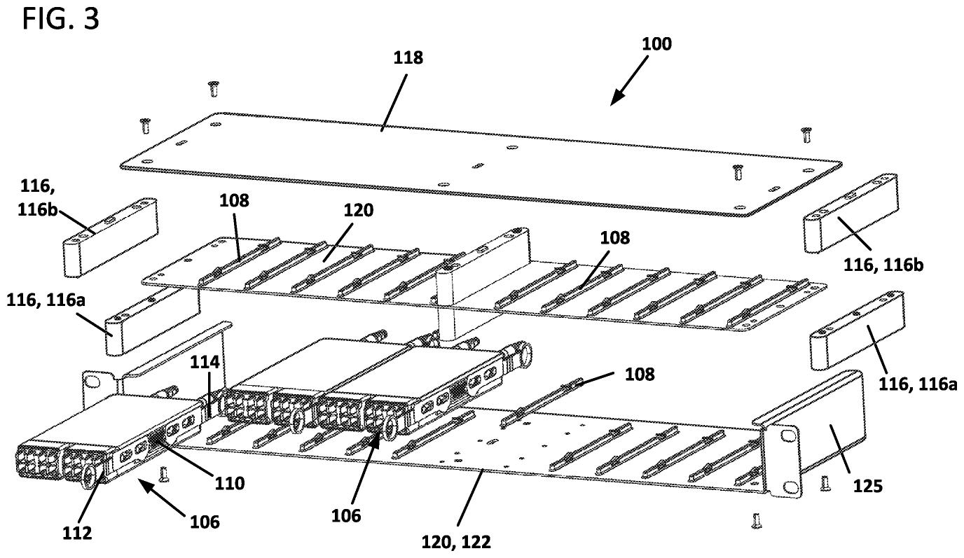

FIGS. 1-6 illustrate a first example implementation of a fiber panel system 100 in which each chamber 104 includes the guides 108 disposed in a row along the lateral axis LA. Accordingly, one or more cassettes 106 can be mounted within each chamber 104 in a row along the lateral axis LA. In some implementations, the guides 108 define flexible stop members to hold a cassette 106 at the guide 108. In other implementations, the guides 108 define stationary stop surfaces against which flexible members of a cassette 106 selectively abut. Examples of both such guides 108 are provided in U.S. Provisional Application No. 63/209,571, filed Jun. 11, 2021, and titled “Cassette Latching Arrangements,” the disclosure of which is hereby incorporated herein by reference in its entirety.

The chassis 102 incudes a top panel 118 and one or more support panels 120. The guides 108 are mounted to each of the support panels 120. One or more spacer walls 116 extend between the top panel 118 and an adjacent support panel 120 to define at least some of the chambers 104. In certain examples, multiple spacer walls 116 are spaced from each other along the lateral axis LA to define the chambers 104 therebetween. In certain implementations, a plurality of the guides 108 can be disposed within each chamber 104 (i.e., between adjacent ones of the spacer walls 116). In certain examples, additional side walls 125 extend between the top panel 118 and the bottom-most support panel 120. In certain examples, the side walls 125 are separate from the spacer walls 116. In certain examples, the side walls 125 are laterally spaced from the spacer walls 116.

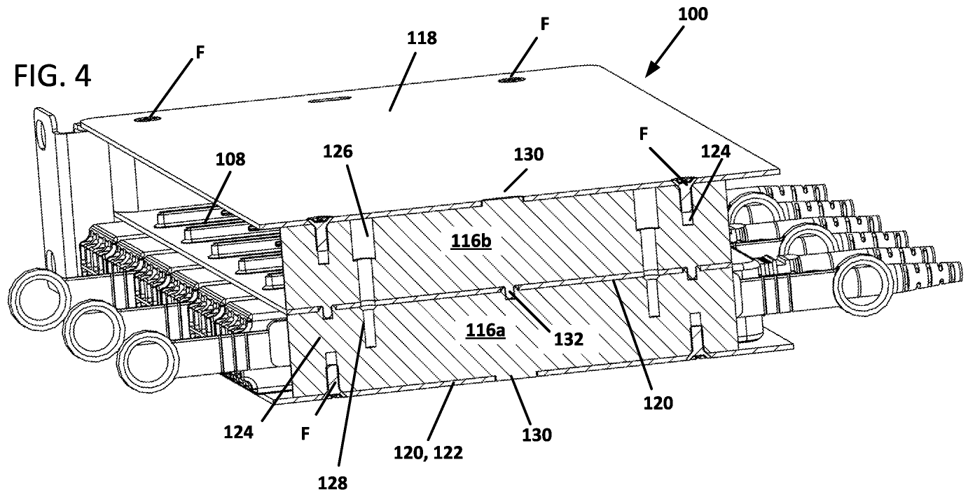

In certain implementations the chassis 102 includes multiple levels. Each level is formed by a respective support panel 120 carrying guides 108 and spacer walls 116. In certain examples, one of the support panels 120 forms a bottom panel 122 of the chassis 102. In certain examples, the spacer walls 116 include first spacer walls 116a extending between the bottom panel 122 and an intermediate support panel 120 and second spacer walls 116b extending between the intermediate support panel 120 and the top panel 118. In certain examples, the second spacer walls 116b are disposed over and vertically aligned with the first spacer walls 116a along the height H of the chassis 102 (e.g., see FIG. 4).

In certain implementations, the first spacer walls 116a are attached (e.g., fastened) to the bottom panel 122 and the second spacer walls 116b are attached (e.g., fastened) to the top panel 118. For example, one or more fasteners F can extend through the top or bottom panels 118, 122 and into fastener apertures 124 of the spacer walls 116 (e.g., see FIG. 4). In certain implementations, the second spacer walls 116b are secured to the first spacer walls 116a. For example, as shown in FIG. 4, the second spacer wall 116b may define a through passage 126 leading to a fastener aperture 128 in the first spacer wall 116a (e.g., see FIG. 4). In certain examples, each spacer wall 116 includes a protrusion 130 configured to fit within a hole in the top panel 118 or bottom panel 122. In certain examples, the second spacer walls 116b include guide pegs 132 configured to extend through the intermediate support panel 120 and into apertures in the respective first spacer walls 116a.

In certain examples, each cassette 106 includes a cassette body 134 carrying a plurality of front port members 136. In certain examples, the front port members 136 define front ports accessible from an exterior of the cassette body 134 and rear ports accessible from an interior of the cassette body 134. In certain examples, the cassette body 134 may carry one or more rear port members. In certain implementations, the latching arrangement 110 of each cassette 106 is configured to align with one of the guide members 108 when the cassette 106 is mounted within one of the chambers 104 of the chassis 102. In certain examples, the cassette body 134 is configured to span over another one of the guides 108. For example, the cassette body 134 may define a bottom channel 138 sized to receive the another one of the guides 108.

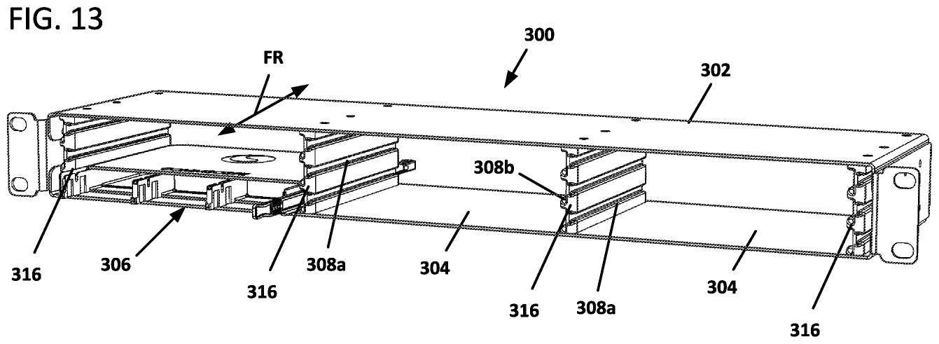

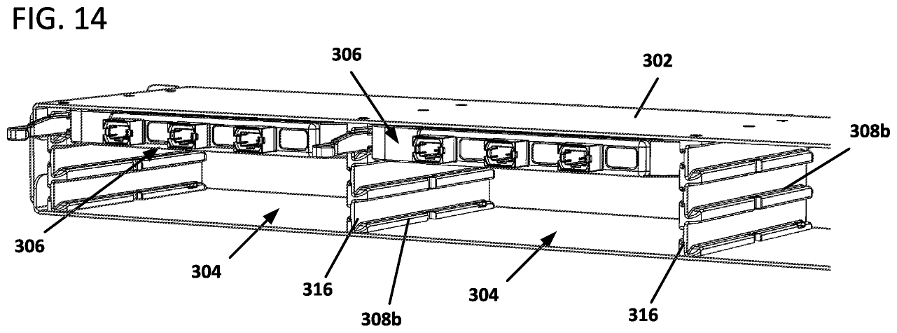

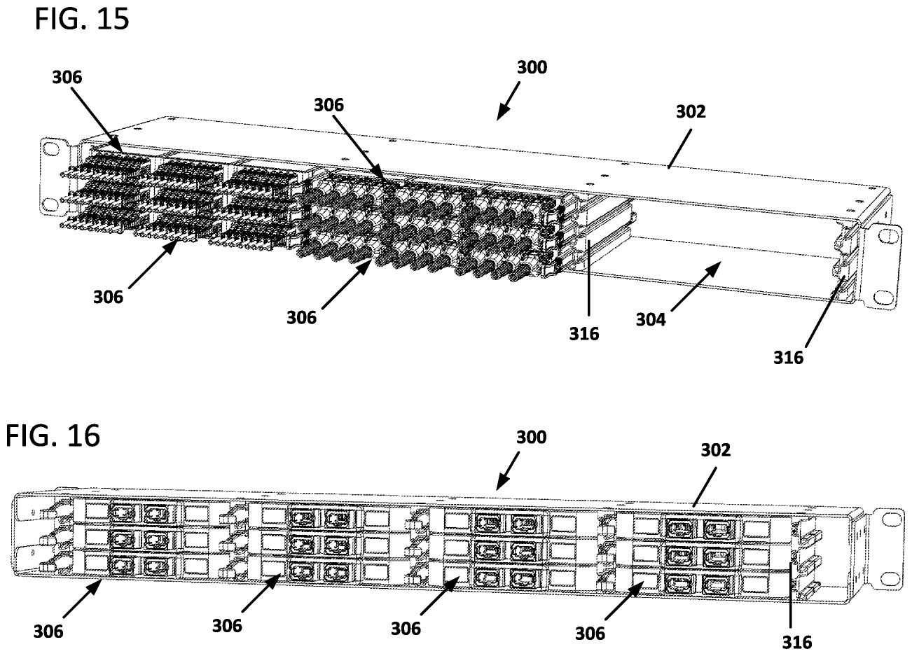

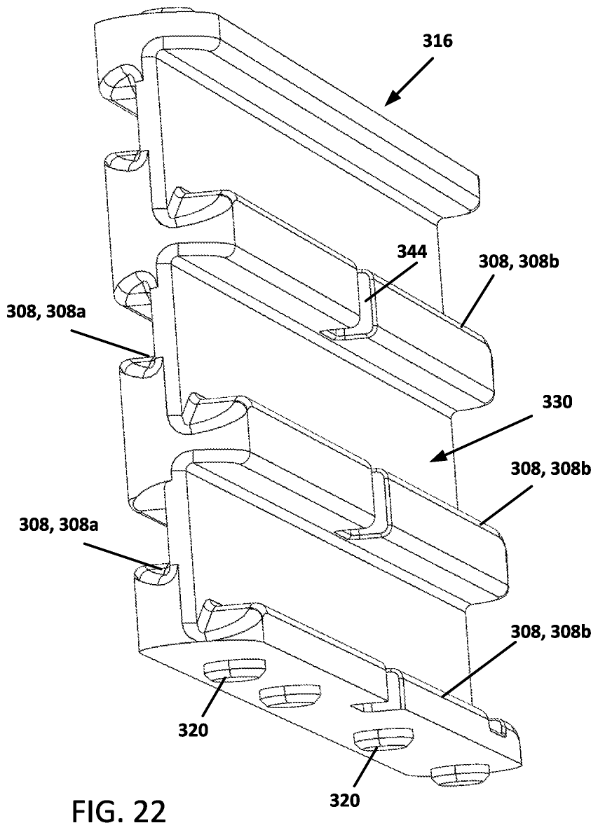

FIGS. 7-12 and 13-24 illustrate second and third example implementations of a fiber panel system 200, 300 in which each chamber 204, 304 includes the guides 208, 308 disposed in a stack along the height H of the chassis 202, 302. In certain examples, each chamber 204, 304 includes a first set of guides 208a, 308a at a first side of the chamber 204, 304 and a second set of guides 208b, 308b at the second side of the chamber 204 opposing the first set of guides 208a. In certain implementations, the first and second sets of guides 208a, 308a, 208b, 308b are defined by spacer walls 216, 316 as will be described in more detail herein. In certain examples, the spacer walls 216, 316 are identical to each other.

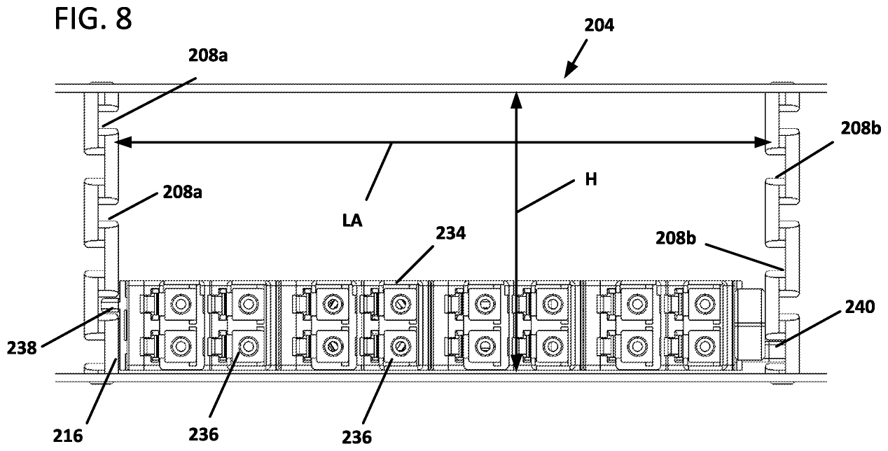

Each cassette 206, 306 mounts between two opposing guides 208, 308. In certain examples, each cassette 206, 306 includes a first rail 238, 338 at a first side and a second rail 240, 340 at an opposite second side (e.g., see FIGS. 8 and 18). The first rail 238, 238 is configured to glide along the first guide 208a, 308a within a chamber 204, 304 and the second rail 240, 340 is configured to glide along a corresponding second guide 208b, 308b within the chamber 204, 304. In some implementations, corresponding ones of the first and second rails 238, 338, 240, 340 align along the lateral axis LA. In other examples, corresponding ones of the first and second rails 238, 338, 240, 340 are offset from each other along the height H of the chassis 202, 302.

In certain implementations, the chassis 202, 302 includes multiple spacer walls 216, 316 separating a top panel 218, 318 and a bottom panel 222, 322. The spacer walls 216, 316 are spaced apart from each other along the lateral axis LA to define chambers 204, 304. Each spacer wall 216, 316 includes top and bottom protrusions 220, 320 that fit within apertures 226, 326 defined in the top and bottom panels 218, 318, 222, 322. In certain implementations, the top and bottom panels 218, 318, 222, 322 each include side flanges 219, 319, 223, 323, respectively, extending transverse to a majority of the panel. In certain examples, the top and bottom panels 218, 318, 222, 322 are identical. In certain implementations, side walls 225, 325 extend between the top and bottom panels 218, 318, 222, 322. In certain examples, the side walls 225, 325 mount to the side flanges 219, 319, 223, 323 of the top and bottom panels 218, 318, 222, 322.

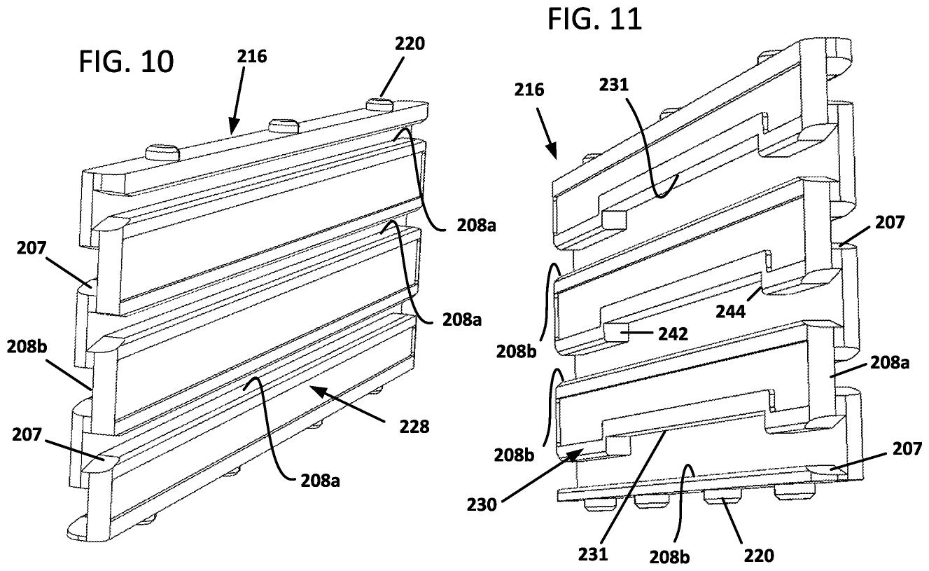

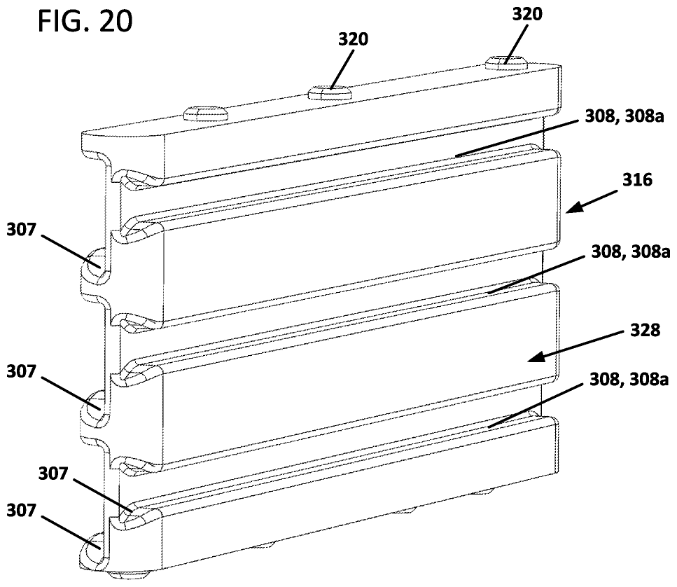

FIGS. 10 and 11 illustrate an example spacer wall 216 suitable for use in the fiber panel 200; FIGS. 20-22 illustrate another example spacer wall 316 suitable for use in the fiber panel 300. Each spacer wall 216, 316 has a first side 228, 328 and an opposite second side 230, 330. The first side 228, 328 of each spacer wall 216, 316 defines the first guides 208a, 308a and the second side 230, 330 of each spacer wall 216, 316 defines the second guides 208b, 308b. In certain examples, the first side 228, 328 of each spacer wall 216, 316 defines multiple first guides 208a, 308a extending parallel to each other and spaced apart along the height H of the fiber panel 200, 300. In certain examples, the second side 230, 330 of each spacer wall 216, 316 defines multiple second guides 208b, 308b extending parallel to each other and spaced apart along the height H of the fiber panel 200, 300. In certain examples, the first guides 208a, 308a are offset from the second guides 208b, 308b along the height H of the chassis 202, 302. In certain examples, each guide 208, 308 defines a ramped or tapered entrances 207, 307 at the front and rear of the guide 208, 308. The first and second rails 238, 338, 240, 340 of a cassette 206, 306 ride over the forward or rearward entrance 207, 307 to reach the guides 208, 308 as the cassette 206, 306 is mounted in the chassis 202, 302.

In the example shown in FIGS. 10 and 11, both the first guides 208a and the second guides 208b of the second fiber panel 200 define flat support surfaces extending along the depth D of the chassis 202 between the forward and rearward entrances 207. In certain implementations, the guides 208 are recessed into the spacer wall 216 to define a channel into which the respective rail 238, 240 of a cassette 206 can extend. In some examples, the channels defined by the first guides 208a are narrower than the channels defined by the second guides 208b (e.g., see FIG. 8). In certain implementations, the channels at the second side 230 of each spacer wall 216 each define a respective vertical recess 231 opposing the support surface of one of the second guides 208b. Each vertical recess 231 is positioned to oppose an intermediate portion of the support surface of the respective guide 208b. Each vertical recess 231 defines a forward-facing shoulder 242 and a rearward-facing shoulder 244 (e.g., see FIG. 11).

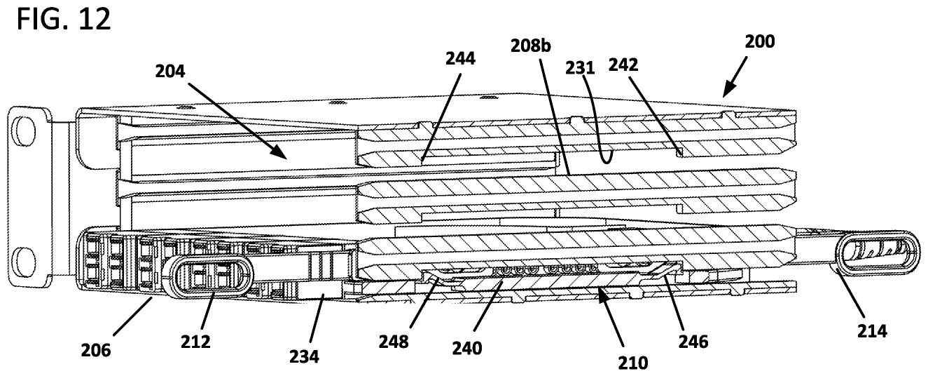

As shown in FIG. 12, a body 234 of a cassette 206 carries forward port members 236 and the latching arrangement 210 as the cassette 206 is mounted within one of the chambers 204 of the panel 200. The latching arrangement 210 includes a first stop member 246 and a second stop member 248 facing in opposite directions. The stop members 246, 248 are flexible between locking and releasing positions. The stop members 246, 248 are resiliently biased to the locking position. The first stop member 246 is configured to oppose the forward-facing shoulder 242 of one of the vertical recesses 231 and the second stop member 246 is configured to oppose the rearward-facing shoulder 244 of the vertical recess 231 when the stop members are disposed in the locking position and the second rail 240 of the cassette 206 is mounted at the respective guide 208b.

In certain implementations, pulling forwardly on the forward arm 212 deflects the second stop member 248 to the releasing position away from the rearwardly-facing shoulder 244, thereby allowing forward movement of the cassette 206 relative to the guide 208b. In certain examples, pushing rearward on the forward arm 212 also deflects the second stop member 248 to the releasing position. In certain implementations, pulling rearwardly on the rearward arm 214 deflects the first stop member 246 to the releasing position away from the forwardly-facing shoulder 242, thereby allowing rearward movement of the cassette 206 relative to the guide 208b. In certain examples, pushing forward on the rearward arm 214 also deflects the second stop member 248 to the releasing position. Further examples of the cassette latching arrangement 210 and respective guide structure 208b are provided in U.S. Provisional Application No. 63/209,571, incorporated by reference above.

In the example shown in FIGS. 20-22, the first guides 308a and second guides 308b define flat support surfaces extending along the forward-rearward axis FR between the forward and rearward entrances 307. In some implementations, the support surfaces of the guides 308, 308a, 308b protrude outwardly from the spacer wall 316. In other implementations, the support surfaces of the guides 308, 308a, 308b recess laterally into the spacer wall 316 to define first channels. In the example shown in FIGS. 20-22, the first guides 308a recess into the spacer wall 316 and the second guides 308b protrude outwardly from the spacer wall 316 to define second channels. In certain examples, the second channels are higher (i.e., extend farther along the height H) than the first channels (e.g., see FIG. 20).

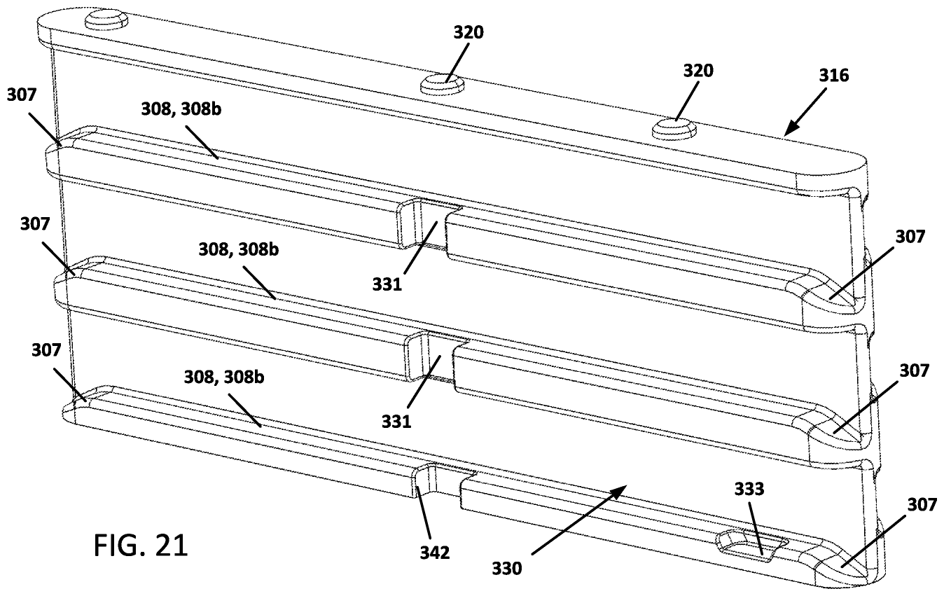

In certain examples, the support surfaces of the first guides 308a are unbroken as they extend between the forward and rearward entrances 307. In certain examples, the support surfaces of the second guides 308b define notches 331 extending into the support surfaces towards the spacer wall 316. In other examples, the notch 331 may extend vertically into the support surface along the height H of the chassis 302. In certain examples, each second guide 308b defines a respective notch 331 at an intermediate position along the forward-rearward axis FR. Each notch 331 defines a forward-facing shoulder 342 and a rearward-facing shoulder 344. In the example shown, the notches 331 align with each other along the height H of the chassis 302 (e.g., see FIG. 21).

In certain examples, one or more of the support surfaces of the second guides 308b also may define one or more additional notches 333. Each additional notch 333 is offset along the forward-rearward axis FR from the notch 331. For example, an additional notch 333 may be provided at or near the forward and/or rearward entrance 307 (e.g., see FIG. 21). In certain examples, the additional notch 333 may define a recess extending downwardly from a top of the support surface of the second guide 308b (e.g., see FIG. 21). In other examples, the additional notch 333 may extend laterally into the second guide 308b.

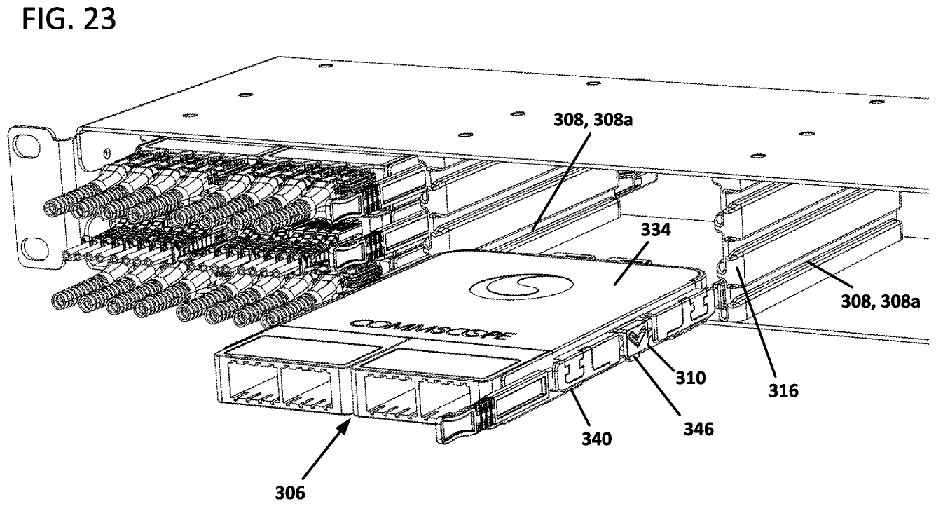

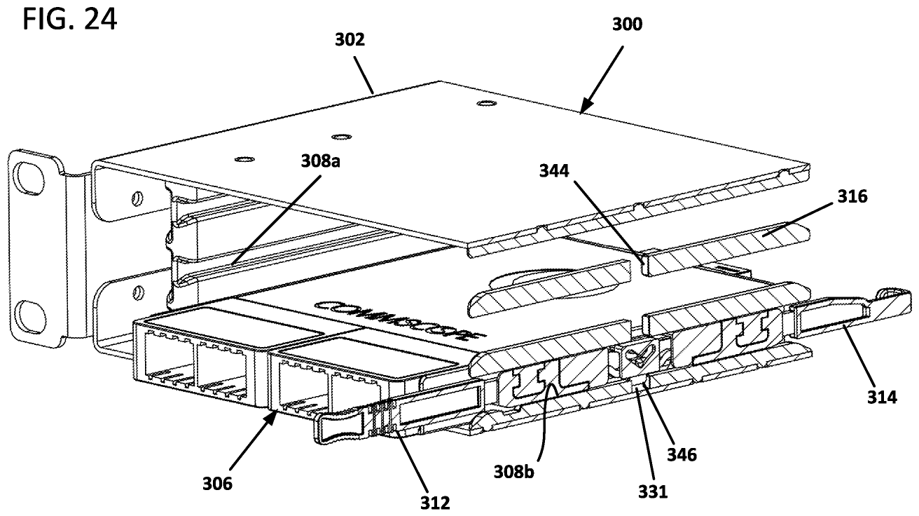

As shown in FIG. 23, a body 334 of a cassette 306 carries the latching arrangement 310 as the cassette 306 is mounted within one of the chambers 304 of the panel 300. In the example shown, the latching arrangement 310 defines the second rail 340. In other examples, the latching arrangement 310 is disposed above the second rail 340. The latching arrangement 310 includes a stop member 346 movable (e.g., along the height H of the chassis 302) between locking and releasing positions. The stop members 346 is resiliently biased to the locking position. The stop member 346 is configured to protrude into the notch 331 of the respective second guide 308b and oppose the forward-facing shoulder 342 and the rearward-facing shoulder 344 to latch the cassette 306 to the chassis 302 when the stop member 346 is disposed in the locking position and the second rail 340 of the cassette 306 is mounted at the respective guide 308b (e.g., see FIG. 24).

In certain implementations, pulling forwardly on the forward arm 312 of the latching arrangement 310 moves (e.g., raises) the stop member 346 to the releasing position away from the rearward-facing shoulder 344, thereby allowing forward movement of the cassette 306 relative to the guide 308b. In certain examples, pushing rearward on the forward arm 312 also moves the stop member 346 to the releasing position. In certain implementations, pulling rearwardly on the rearward arm 314 moves the stop member 346 to the releasing position away from the forward-facing shoulder 342, thereby allowing rearward movement of the cassette 306 relative to the guide 308b. In certain examples, pushing forward on the rearward arm 314 also moves (e.g., raises) the stop member 346 to the releasing position. In certain examples, the stop member 346 of the latching arrangement 310 may also catch on the additional notch(es) 333 to releaseably lock the cassette 306 in one or more additional positions. Further description of the cassette latching arrangement 310 and respective guide structure 308b are provided in U.S. Provisional Application No. 63/209,571, incorporated by reference above.

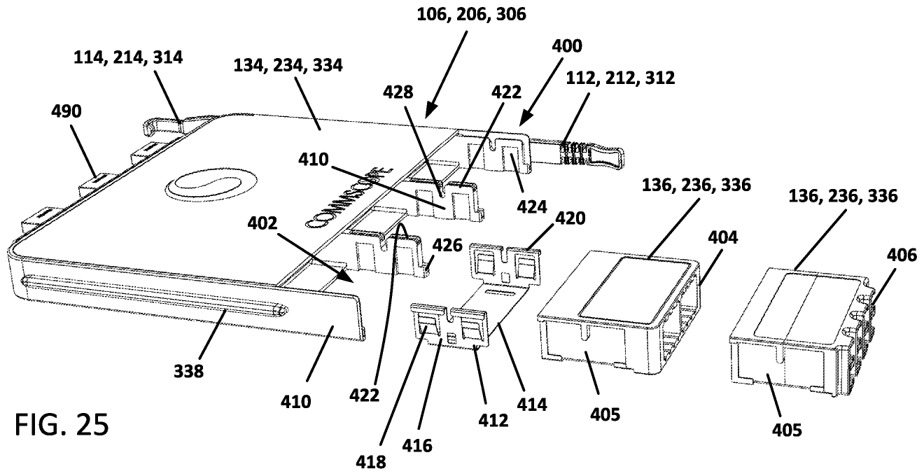

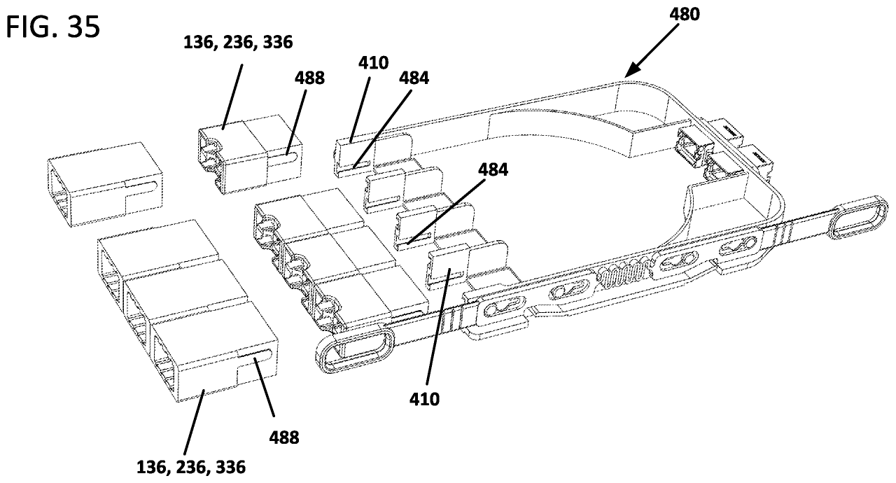

FIGS. 25-38 illustrate various port member mounting arrangements 400, 440, 460, 480 suitable for use as any of cassettes 106, 206, 306 disclosed above. The port member mounting arrangements 400, 420, 440, 460, 480 are each configured to hold the forward port members 136, 236, 336 at mounting positions 402 forward of a main body 134, 234, 334 of the cassette 106, 206, 306 so that the forward port members 136, 236, 336 do not seat on a bottom surface of the main body 134, 234, 334 of the cassette 106, 206, 306. While multiple port member options are shown in FIGS. 25, 30, 32, and 34, each mounting position 402 receives only one port member 136, 236, 336. In certain examples, if the cassette 106, 206, 306 includes a cover closing the interior, then the cover does not extend over the forward port members 136, 236, 336. Rather, the port member mounting arrangements 400, 440, 460, 480 includes arms 410 extending forwardly of the main body 134, 234, 334 and cover of the cassette 106, 206, 306 and spaced apart from each other along the lateral axis LA to define the mounting positions 402 for the forward port members 136, 236, 336.

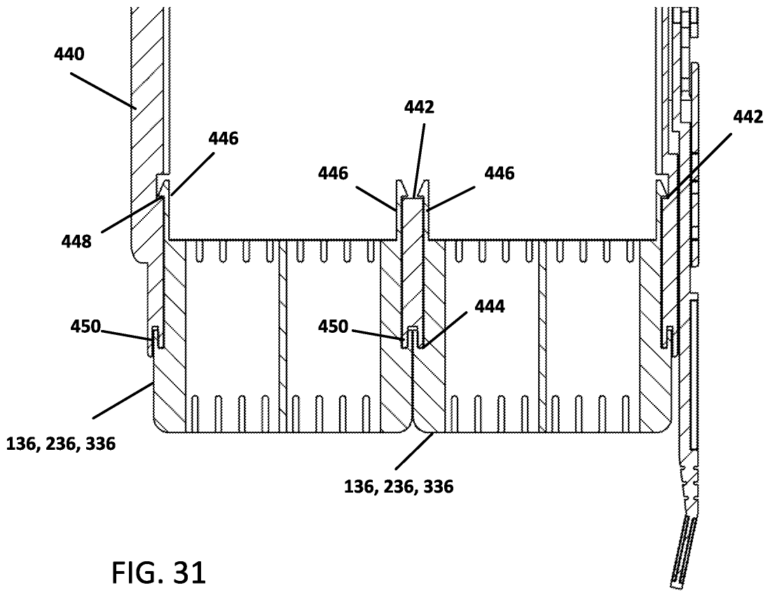

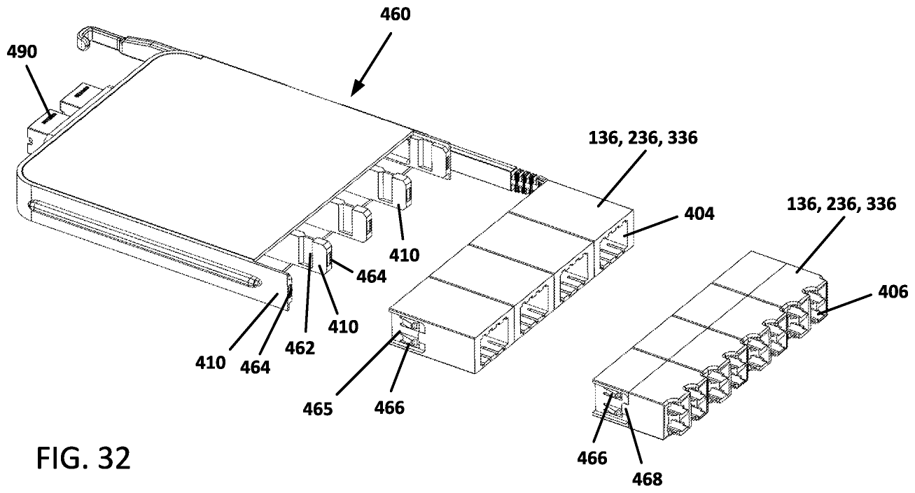

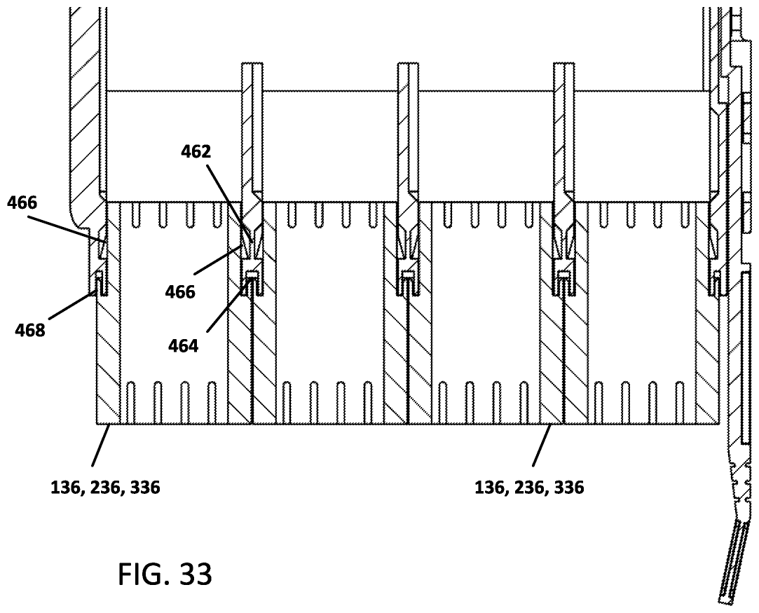

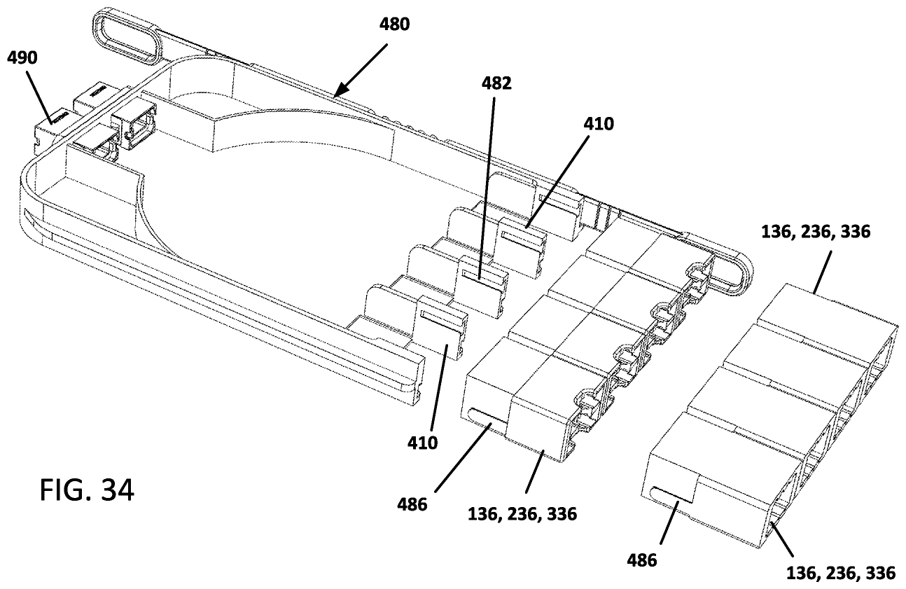

FIGS. 25-29 illustrate a first example port member mounting arrangement 400 in which the arms 410 are configured to receive the forward port members 136, 236, 336 using separate resilient support members 412. FIGS. 30-31 illustrate a second example port member mounting arrangement 440 in which the arms 410 are configured to mate with rearwardly extending latch arms 446 of the forward port members 136, 236, 336. FIGS. 32-33 illustrate a third example port member mounting arrangement 460 in which the arms 410 are configured to receive latching tabs 466 of the forward port members 136, 236, 336. FIGS. 34-36 illustrate a fourth example port member mounting arrangement 480 in which the arms 410 defines part of an interlock arrangement 485 to receive the forward port members 136, 236, 336.

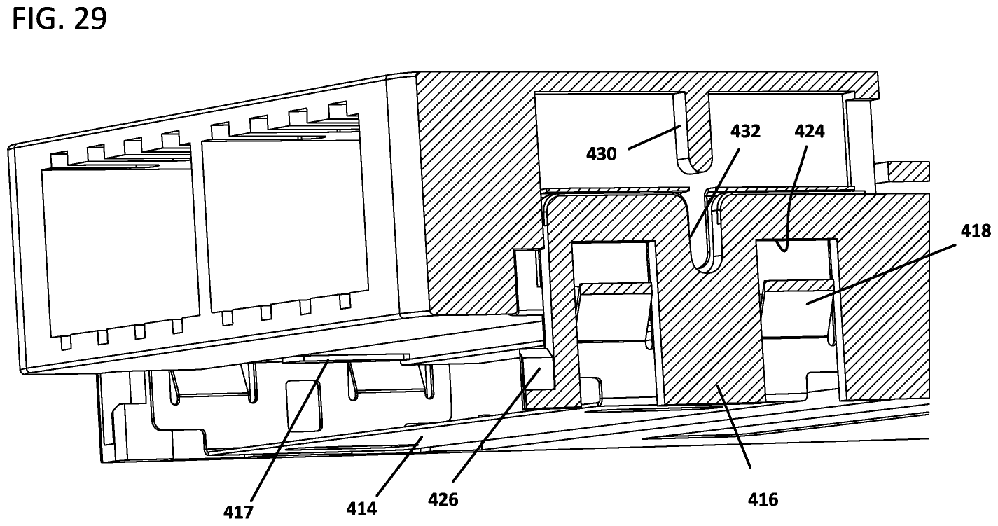

In FIGS. 25-29, the resilient support member 412 includes a webbing 414 extending between opposite side flanges 416. When the support member 412 is mounted to a port member 136, 236, 336, the webbing 414 extends beneath the port member 136, 236, 336 so that the port member 136, 236, 336 seats on the webbing 414. In certain examples, the port member 136, 236, 336 is configured to engage the webbing 414 to limit movement of the port member 136, 236, 336 relative to the support member 412. For example, the webbing 414 and the port member 136, 236, 336 may engage each other through protrusions and apertures. In the example shown, the webbing 414 defines apertures 415 sized to receive protrusions 417 at the bottom of the port member 136, 236, 336 (e.g., see FIG. 28).

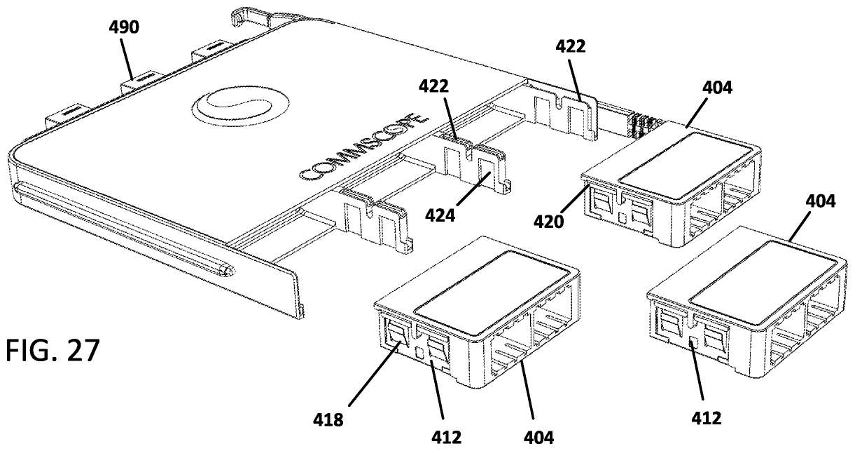

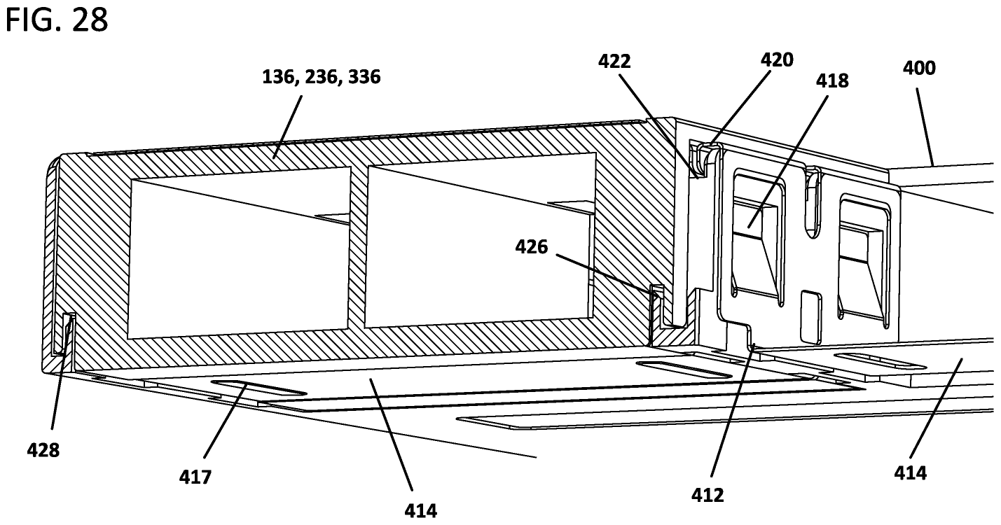

In certain examples, each port member 136, 236, 336 defines oppositely facing recesses 405 in which the side flanges 416 are disposed (e.g., see FIG. 27). Interaction between the side flanges 416 and the recesses 405 inhibit forward or rearward movement of the port member 136, 236, 336 relative to the support member 412. In certain examples, the recesses 405 have open bottoms to facilitate mounting of the support member 412 through sliding motion from the bottom of the port member 136, 236, 336. Each of the side flanges 416 defines hooks 420 and flexible tabs 418 to secure the support member 412 to the arms 410. In certain examples, each side flange 416 defines multiple hooks 420 and multiple tabs 418.

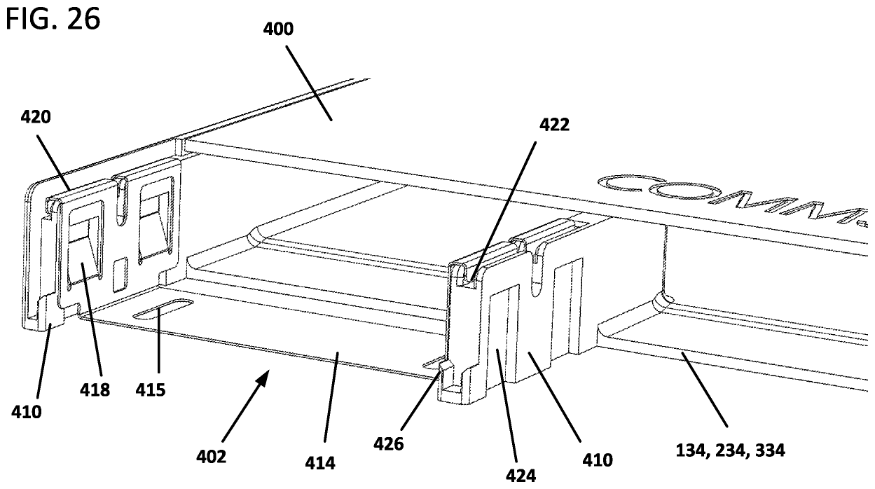

In certain implementations, the top of each of the arms 410 are configured to receive the hooks 420 of at least one of the support members 412. For example, the tops of the arms 410 may define slots 422. Engagement between the hooks 420 and the tops of the arms 410 allows the support members 412 to hang from the arms 410 (e.g., see FIGS. 26 and 28). The tabs 418 are resiliently biased outwardly into recesses 424 defined in sides of the arms 410. The tabs 418 are oriented so allow the support member 412 to be slid downwardly over two adjacent arms so that the hooks 420 enter the slots 422 (e.g., see FIG. 25). For example, the tabs 418 are oriented to cam inwardly as the tabs 418 slide downwardly along the arms 410. Upon reaching the recesses 424, the tabs 418 deflect outwardly into the recesses 424, thereby inhibiting upward movement of the support member 412 relative to the arms 410.

In certain implementations, the arms 410 are configured to directly engage the port members 136, 236, 336. For example, the arms 410 may defines protrusions 426 sized to fit within slots 428 defined in the port members 136, 236, 336 (e.g., see FIG. 28). In the example shown, the protrusions 426 are disposed at forward ends of the arms 410. In certain examples, the slots 428 are disposed at the bottoms of the port members 136, 236, 336. Accordingly, port members 136, 236, 336 can be mounted to the arms 410 by sliding the port members 136, 236, 336 downwardly along the height H of the chassis 102, 202, 302. In certain examples, the protrusions 426 further support the port member 136, 236, 336

In certain implementations, the port member 136, 236, 336 may include a protrusion 430 that fits within a slot 432 defined in the arm 410. In the example shown, the support member 412 also defines a slot in alignment with the slot 432 in the arm 410 when the support member 412 is mounted to the arm 410. The protrusion 430 of the port member 136, 236, 336 is disposed within both slots 432 when the port member 136, 236, 336 is mounted at the cassette 106, 206, 306. In certain examples, engagement between the protrusion 430 and the slot 432 further inhibits forward and/or rearward movement of the port member 136, 236, 336 relative to the cassette 106, 206, 306.

FIGS. 30 and 31 illustrate an example port member mounting arrangement 440 including arms 410 configured to engage latch arms 446 of the port members 136, 236, 336. The arms 410 define rearward-facing shoulders 442 over which hooks 448 of the latch arms 446 snap when the port member 136, 236, 336 is mounted to the cassette 106, 206, 306. Engagement between the hooks 448 and the shoulders 442 inhibits forward movement of the port member 136, 236, 336 relative to the cassette 106, 206, 306. In certain implementations, the port members define rearwardly extending fingers 450 that fit within slots 444 defined in the arms 410. In certain examples, engagement of the fingers 450 within the slots 444 inhibits continued rearward movement of the port member 136, 236, 336 relative to the cassette 106, 206, 306. In certain examples, engagement of the fingers 450 within the slots 444 inhibits movement of the port 106 136, 236, 336 relative to the cassette 106, 206, 306 along the lateral axis LA and/or the height H of the chassis 102, 202, 302.

FIGS. 32 and 33 illustrate an example port member mounting arrangement 460 including arms 410 configured to receive latching tabs 466 of the forward port members 136, 236, 336. Each arm 410 defines at least one recess 462 facing along the lateral axis LA. Inner ones of the arms 410 define oppositely facing recesses 462. In certain examples, each arm 410 also defines a forwardly-facing slot 464. Each port member 136, 236, 336 defines oppositely facing recessed side portions 465 in which one or more resilient tabs 466 are disposed. Each tab 466 extends outwardly from the respective recessed side portion 465. A rearward-facing tab 468 extends across each recessed side portion 465. When the port member 136, 236, 336 is mounted to the port member mounting arrangement 460, the tabs 466 deflect into the recessed side portions 465 and flex outwardly when aligned with the recesses 462 in the arms 410 to latch the port member 136, 236, 336 relative to the cassette 106, 206, 306 along the forward-rearward axis FR. The rearward-facing tabs 468 slide into the forward slots 464 to hold the port member 136, 236, 336 relative to the cassette 106, 206, 306 along the lateral axis LA and/or the height H.

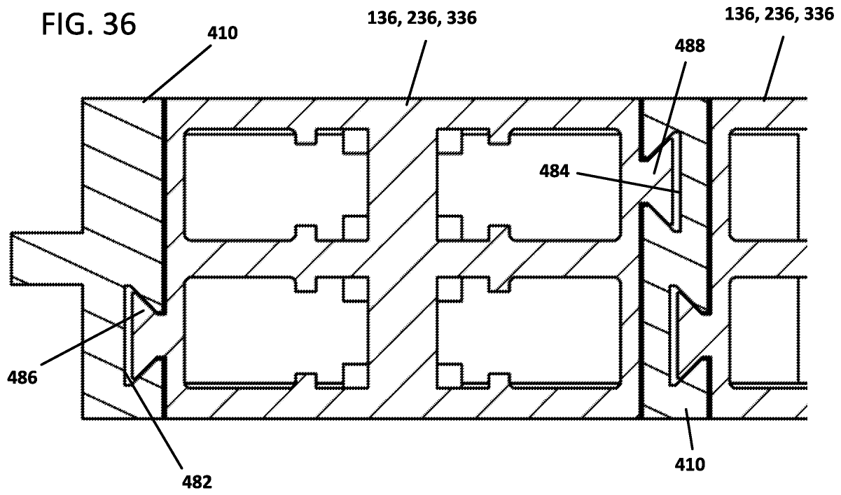

FIGS. 34-36 illustrate a fourth example port member mounting arrangement 480 in which the arms 410 define part of an interlock arrangement 485 and the forward port members 136, 236, 336 define the other part of the interlock arrangement 485. In some implementations, each mounting position 402 has a first channel 482 defined at an arm 410 at a first side of the mounting position 402 and a second channel 484 defined at another arm 410 at the opposite second side of the mounting position 402. Each port member 136, 236, 336 includes a first protrusion 486 at a first side and a second protrusion 488 at a second side. The first and second protrusions 486, 488 are configured to fit within the channels 482, 484, respectively (e.g., see FIG. 36). In other implementations, the arms 410 include the protrusions and the port members 136, 236, 336 define the channels.

In certain examples, the first channel 482 is offset along the height H relative to the second channel 484. In certain examples, outer ones of the arms 410 define only one channel 482, 484 while inner ones of the arms 410 define two oppositely-facing channels 482, 484. Offsetting the channels 482, 484 allows each channel 482, 484 to extend along a majority of a width of the respective arm 410. In certain examples, the first and second channels 482, 484 have a common size. In certain examples, the first and second channels 482, 484 have a common shape. In the example shown, the protrusions 486, 488 and channels 482, 484 have a dovetail shape.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A fiber panel system comprising:
a chassis defining an interior extending along a forward-rearward axis between a front end and a rear end, extending along a lateral axis between opposite first and second sides, and extending along a height between a top and a bottom; and
a spacer wall disposed within the interior of the chassis, the spacer wall having a first side facing in a first direction along the lateral axis and a second side facing in an opposite second direction along the lateral axis, the first side of the spacer wall defining a first plurality of parallel support surfaces extending along the forward-rearward axis, and the second side of the spacer wall defining a second plurality of parallel support surfaces extending along the forward-rearward axis, the second support surfaces being offset from the first support surfaces along the height of the chassis.

2. The fiber panel system of claim 1, wherein the spacer wall is one of a plurality of spacer walls disposed within the interior of the chassis, the spacer walls being spaced apart from each other along the lateral axis to divide the interior into a plurality of parallel through-passages.

3. The fiber panel system of claim 2, wherein the spacer walls are identical to each other.

4. The fiber panel system of claim 2, further comprising a cassette configured to mount within the interior of the chassis, the cassette extending along the lateral axis between a first end and a second end, the cassette including a first rail disposed at the first end and a latching arrangement disposed at the second end, the first rail being configured to glide over one of the support surfaces at the first side of a first of the spacer walls and the latching arrangement being configured to glide over one of the support surfaces at the second side of a second of the spacer walls.

5. The fiber panel system of claim 4, wherein the cassette is a first cassette; and
wherein a second cassette is configured to mount within the interior of the chassis between the first and second spacer walls, the second cassette being offset from the first cassette along the height of the chassis.

6. The fiber panel system of claim 5, wherein a bottom surface of the first cassette directly opposes a top surface of the second cassette.

7. The fiber panel system of claim 5, further comprising a third cassette configured to mount within the interior of the chassis between the second spacer wall and a third of the spacer walls, the third cassette being aligned with the first cassette along the lateral axis.

8. The fiber panel system of claim 4, wherein the cassette carries a plurality of front port members having front ports accessible from an exterior of the cassette and a plurality of rear ports accessible from an interior of the cassette.

9. The fiber panel system of claim 8, wherein the front ports of the front port members are configured to receive vertically oriented plug connectors.

10. The fiber panel system of claim 8, wherein the front ports of the front port members are configured to receive LC plug connectors.

11. The fiber panel system of claim 8, wherein the front ports of the front port members are configured to receive SN plug connectors.

12. The fiber panel system of claim 8, wherein the front ports of the front port members are configured to receive MPO plug connectors.

13. The fiber panel system of claim 8, wherein the cassette carries a rear port member having a front port accessible from the interior of the cassette and a rear port accessible from the exterior of the cassette.

14. The fiber panel system of claim 1, wherein the chassis includes a bottom panel, a top panel, and opposite side panels that cooperate to define the interior.

15. The fiber panel system of claim 14, wherein the spacer wall is secured to the bottom panel and to the top panel.

16. The fiber panel system of claim 15, wherein each spacer wall includes lower protrusions that extend into apertures defined in the bottom panel and upper protrusions that extend into apertures defined in the top panel.

17. The fiber panel system of claim 1, wherein the support surfaces of the second plurality define notches.

18. The fiber panel system of claim 17, wherein each support surface of the second plurality defines a plurality of notches along the forward-rearward axis.

19. The fiber panel system of claim 17, wherein the support surfaces of the first plurality do not define notches.

20. The fiber panel system of claim 1, wherein intermediate portions of the support surfaces of the second plurality oppose a vertical recesses.

21. A fiber panel system comprising:
a chassis including:
a body extending along a forward-rearward axis between a front and a rear, along a lateral axis between opposite first and second sides, and along a height between a top and a bottom, the chassis defining a plurality of chambers each extending along the forward-rearward axis;
a plurality of spacer walls disposed within the chassis to separate the chambers;
a respective plurality of guides disposed within each chamber, each guide extending along the forward-rearward axis; and
a plurality of cassettes configured to be disposed within the chassis, each cassette including a body carrying a plurality of front ports, each body defining a channel configured to be aligned with one of the guides when the respective cassette is mounted at the chassis, each body carrying a latching arrangement configured to be aligned with another of the guides when the respective cassette is mounted at the chassis, each latching arrangement cooperating with the respective another of the guides to latch the cassette at the chassis.

22-28. (canceled)

29. A cassette comprising:
a body including opposite sidewalls extending upwardly from a bottom floor to define an interior extending between a front end and a rear end;
a plurality of parallel arms extending forwardly of the body so that the arms protrude beyond the bottom floor, the arms being laterally spaced to define a plurality of mounting positions therebetween; and
a plurality of ports members mounted to the arms at the mounting positions, each of the port members being disposed forward of the bottom floor so that none of the port members seat on the bottom floor.

30-39. (canceled)

40. A cassette comprising:
a body including opposite first and second sidewalls extending upwardly from a bottom floor to define an interior, each of the sidewalls extending along a forward-rearward axis of the body, the first and second sidewalls being spaced from each other along a lateral axis;
a first rail disposed at the first sidewall, the first rail extending along the forward-rearward axis;
a second rail disposed at the second sidewall, the second rail being offset along a height of the body from the first rail, the height of the body being transverse to the forward-rearward axis and to the lateral axis.

41. A cassette comprising:
a body including opposite first and second sidewalls extending upwardly from a bottom floor to define an interior, each of the sidewalls extending along a forward-rearward axis of the body, the first and second sidewalls being spaced from each other along a lateral axis;
a rail disposed at the first sidewall, the rail extending along the forward-rearward axis;
a latching arrangement disposed at the second sidewall, the latching arrangement including a forward arm extending forwardly beyond the body and a rearward arm extending rearwardly beyond the body, the latching arrangement having a different thickness than the rail.

42. (canceled)
